(19) United States
(12) Patent Application Publication
(10) Pub. No.: US 2007/0083585 A1
(43) Pub. Date: Apr. 12, 2007

(54) Karatsuba based multiplier and method

(75) Inventors: Thomas J. St Denis, Kanata (CA); Neil F. Hamilton, Kanata (CA)

Correspondence Address: FREEDMAN & ASSOCIATES, 117 CENTREPOINTE DRIVE, SUITE 350, NEPEAN, ONTARIO, K2G 5X3, CA

(73) Assignee: Elliptic Semiconductor Inc., Kanata (CA)

(21) Appl. No.: 11/245,182

(22) Filed: Oct. 7, 2005

Related U.S. Application Data
(60) Provisional application No. 60/701,990, filed on Jul. 25, 2005.

(51) Int. Cl. G06F 7/00

(52) U.S. Cl. 708/492

(57) ABSTRACT

A method of multiplying large integers is disclosed. Two large numbers, x and y, are provided. values are determined in accordance with the Karatsuba multiplication process based on x and y. A first and second value according to the Karatsuba multiplication method are also determined. The third value for use in accordance with the Karatsuba multiplication method is determined by determining C′=(x₁+x₂)[m−1:0]*(y₁+y₂)[m−1:0] and determining C=C′+((y₁+y₂)[2m:2m] AND (x₁+x₂)[m−1:0]+(x₁+x₂)[2m:2m] AND (y₁+y₂)[m:0])<<m, where << is a bitwise shift operation, wherein AND is performed by performing a Boolean AND of a single bit within a first operand with each bit within a second operand and wherein D[j:k] refers to the jth to kth bits of D.

### FIELD OF THE INVENTION

The invention relates to arithmetic processing and more particularly to multiplication of large numbers based on a process discovered by Karatsuba et. al.

### BACKGROUND

In school, most children learn to multiply. A major advantage of positional numeral systems over other systems of writing down numbers is that they facilitate the usual grade-school method of long multiplication. In grade school, it is taught to multiply each digit of one of the multiplicands by the other multiplicand to form an interim product. These interim products are shifted and added to result in the product of the multiply operation.

In order to perform this process, one needs to know the products of all possible digits, which is why multiplication tables are memorized by youngsters. Humans use this process in base 10, while computers employ a similar process in base 2. The process is a lot simpler in base 2, since the multiplication table has only 4 entries. Rather than first computing the products, and then adding them all together in a second phase, computers add each interim product to the result as they are computed. Modern chips implement this process for 32-bit or 64-bit numbers in hardware or in microcode. To multiply two numbers with n digits using this method, a processor involves n² operations. More formally: the time complexity of multiplying two n-digit numbers using long multiplication is O(n²).

The same skill for multiplying numbers taught in grade school are applicable to multiplication of very large numbers. Unfortunately, for multiplying very large numbers, this process becomes quite inefficient due to the fact that it is related to O(n²). For example, multiplying two one hundred digit numbers together requires one hundred multiply operations each requiring one hundred 1-bit multiplications, one hundred shift operations, and one hundred additions with a result requiring up to 200 digits. Thus, the process is effected in 200 digit space consuming considerable processor resources.

An old method for multiplication, that does not require multiplication tables, is the Peasant multiplication process. This is actually a method of multiplication using base 2. A similar technique is still in use in computers where a binary number is multiplied by a small integer constant. Since multiplication of a binary number by powers of two is expressible in terms of bit-shifts, a series of bit shifts and addition operations which has the effect of performing a multiplication without the use of any conditional logic or hardware multiplier results. For many processors, this is often the fastest way to perform simple multiplication operations.

For systems that need to multiply huge numbers in the range of several hundreds or several thousand digits, such as computer algebra systems and bignum libraries, the above methods are too slow. A known process for improving efficiency in large number multiplication is to employ Karatsuba multiplication, discovered in 1962. Karatsuba multiplication is based on decomposing each of the multiplicands to result in smaller operators for being combined in accordance with the process to result in the product. Karatsuba multiplication is time wise efficient and also space wise efficient for multiplying significantly large numbers.

Karatsuba multiplication is explained hereinbelow by way of an example for base 10 multiplication of two n-digit numbers x and y, where n is even and equal to 2m.

Arbitrarily, x and y are defined as follows:
i) x=x₁10^{m}+x₂
ii) y=y₁10^{m}+y₂

with m-digit numbers x₁, x₂, y₁ and y₂. Thus, the product is given by
i) xy=x₁y₁10^{2m}+(x₁y₂+x₂y₁)10^{m}+x₂y₂

requiring a determination of x₁y₁, x₁y₂+x₂y₁ and x₂y₂. Preferably, this determination is efficient. The heart of Karatsuba multiplication lies in the observation that these four products are determinable with three rather than four multiplication operations. This is achievable as follows:

i) compute x₁y₁, call the result A

ii) compute x₂y₂, call the result B

iii) compute (x₁+x₂)(y₁+y₂), call the result C, and

iv) compute C−A−B; this number is equal to x₁y₂+x₂y₁.

To compute these three products of m-digit numbers, optionally the same trick is used again. This allows for a recursive process to determine the product. Optionally, recursion is not used and the m-digit numbers are processed directly. Once the numbers are determined, addition is used to combine them. Since addition takes time typically of the order O(n)—linearly related to m—the computational expenses of increasing the size of the very large numbers is linear and, as such, the process is efficient for large values.

If T(n) denotes the time it takes to multiply two n-digit numbers with Karatsuba multiplication, then we can write
i) T(n)=3 T(n/2)+cn+d
for some constants c and d, and this recurrence relation is solvable, giving a time complexity of Θ(n^{ln(3)/ln(2)}). The number ln(3)/ln(2) is approximately 1.585, so this method is significantly faster than long multiplication. Because of the overhead of recursion, Karatsuba multiplication is not very fast for small values of n; therefore, typical computer based implementations switch to long multiplication if n is below some threshold.

When n is odd or when the operands are not of the same length, typically zeros are added at the left end of x and/or y to result in these criteria being met. For most computer implementations, the same method as described above is implemented in base 2 (binary).

It would be advantageous to further reduce the complexity of multiplying two large numbers.

### SUMMARY OF THE INVENTION

In accordance with the invention there is provided a method of multiplying integers x and y comprising: determining a value of x₁ and of x₂ such that x=x₁a^{m}+x₂, a is an integer; determining a value of y₁ and y₂ such that y=y₁a^{m}+y₂, a is an integer; determining A=x₁y₁; determining B=x₂y₂; and determining C by performing an m bit multiplication operation and absent a multiplication operation having operands having a length greater than m.

In accordance with an embodiment C is determined as follows: determining C′=(x₁+x₂)[m−1:0]*(y₁+y₂)[m−1:0]; and determining C=C′+((y₁+y₂)[2m:2m] AND (x₁+x₂)[m−1:0]+(x₁+x₂)[2m:0] AND (y₁+y₂)[m/2:0])<<m.

In accordance with another aspect of the invention there is provided a circuit comprising: a decomposition circuit for determining a value of x₁ and of x₂ such that x=x₁a^{m}+x₂ and for determining a value of y₁ and y₂ such that y=y₁a^{m}+y₂, a is an integer; a multiplier circuit for determining A=x₁y₁ and B=x₂y₂; and a third circuit for determining C by performing an m bit multiplication operation and absent a multiplication operation having operands having a length greater than m.

In accordance with another embodiment of the invention the third circuit includes Boolean circuitry for determining C′=(x₁+x₂)[m−1:0]*(y₁+y₂)[m−1:0] and for determining C=C′+((y₁+y₂)[2m:0] AND (x₁+x₂)[m−1:0]+(x₁+x₂)[2m:0] AND (y₁+y₂)[m:0])<<m, where << is a bitwise shift operation, wherein AND is performed by performing a Boolean AND of a single bit within a first operand with each bit within a second operand and wherein D[j:k] refers to the jth to kth bits of D.

In accordance with yet another aspect of the invention there is provided a storage medium having data stored therein, the data for when executed resulting in a circuit design comprising: a decomposition circuit for determining a value of x₁ and of x₂ such that x=x₁a^{m}+x₂ and for determining a value of y₁ and y₂ such that y=y₁a^{m}+y₂, a is an integer; a multiplier circuit for determining A=x₁y₁ and B=x₂y₂; and a third circuit for determining C by performing an m bit multiplication operation and absent a multiplication operation having operands having a length greater than m.

In accordance with an embodiment the third circuit includes Boolean circuitry for determining C′=(x₁+x₂)[m−1:0]*(y+y₂)[m−1:0] and for determining C=C′30 ((y₁+y₂)[2m:2m] AND (x₁+x₂)[m−1:0]+(x₁+x₂)[2m:2m] AND (y₁+y₂)[m:0])<<m, where << is a bitwise shift operation, wherein AND is performed by performing a Boolean AND of a single bit within a first operand with each bit within a second operand and wherein D[j:k] refers to the jth to kth bits of D.

### BRIEF DESCRIPTION OF THE DRAWINGS

The invention will now be described with reference to specific examples as shown in the attached drawings in which similar reference numerals refer to similar elements and in which:

FIG. 1 is a simplified flow diagram of a method according to an embodiment of the invention;

FIG. 2 is a simplified flow diagram of a recursive embodiment of the invention; and,

FIG. 3 is a simplified block diagram of a circuit according to an embodiment of the invention.

### DETAILED DESCRIPTION OF AN EMBODIMENT OF THE INVENTION

Several facts are worth mentioning

The term C is always greater than the sum A+B.

The term C is determined with a (m+1)-digit multiplication routine whereas the terms A and B are determined using n-digit multiplications.

The first fact is essentially the basis for choosing this approach, as a simple unsigned subtraction is useful for calculating the middle term, C. The second fact indicates that calculation of C is more complicated than calculation of A or B. A traditional multiplication of two m-digit numbers requires m² multiplications (order O(n²)).

For example, in a typical construction, a possible operation is to multiply 1024-bit numbers with 32-bit digits. This is accomplished with two half size multiplications of (512/32)²=256 digit multiplications each. The third multiplication for the C term would rely on (512/32+1)²=289 multiplications—a growth in the critical path of 12%. In particular the penalty is higher for smaller numbers than for larger numbers, impacting the ability to use Karatsuba recursively. For 512-bit numbers multiplied with 32-bit digits, the overhead for Karatsuba multiplication is 26%.

In accordance with the present embodiment, computation of C is rearranged such that an m-digit multiplication is sufficient and a constant additional latency after the multiplication corrects the resulting product. As a result, for smaller large numbers there is a significant shortening of a critical computation path. This is particularly the case when a hardware implementation of a Karatsuba multiplier incorporates multiple layers of Karatsuba have been applied, for example to achieve a 128×128 multiplier that is significantly easier to route.

For determining C in the present embodiment both x and y are the same bit length and m represents the number of bits in x. When this is not the case, padding of the values is applied as zeros are added at the left side of the appropriate operand, x or y. The determination of C proceeds as follows:
C:=(x₁+x₂)[m−1:0]*(y₁+y₂)[m−1:0]
C:=C+((y₁+y₂)[2m:0]AND(x₁+x₂)[m−1:0]+(x₁+x₂)[2m:0]AND(y₁+y₂)[m:0])<<m

where D[j:k] indicates bits j down to k of D, the “<<” operator impresses a shift left of bits within the first operand (left hand side) by an amount indicated by a second operand (right hand side), and where an AND operation indicates a bitwise AND operation of one bit of a first operand (from the left hand side) against each of the bits of the second operand (right hand side). The AND operation is preferably performed in parallel for all bits and results in a same number of bits as was originally within the second operand.

These steps result in a computation only relying upon a half-size multiplier (m/2) thus saving multiplication time and reducing complexity. The computation inserts two additions to the critical path—one half-size and one half-size plus one bit. Additions, which are on the order of O(n)-scale linearly with increased bit size, are easier to route due to the hardware simplicity and are easier to time once the multiplication operation is completed. Thus, the above noted steps result in a large number multiplication requiring fewer resources and/or more scalable in nature without incurring a significant additional delay.

The above described embodiment like Karatsuba multiplication is the process of multiplying two numbers. The process supports parallel, serial and/or recursive half-sized multiplications. Further, the half-size multiplications are further subject to multiplication using the above-described process. Karatsuba multiplication carries a significant penalty as traditionally implemented in hardware. It either grows one of the half-size multiplications thereby requiring additional work, or it uses a different data flow requiring additional logic. Thus, implementing Karatsuba in hardware in an efficient manner is problematic. The above-described embodiment provides a data flow specifically for hardware implementation, shortening the traditional critical path.

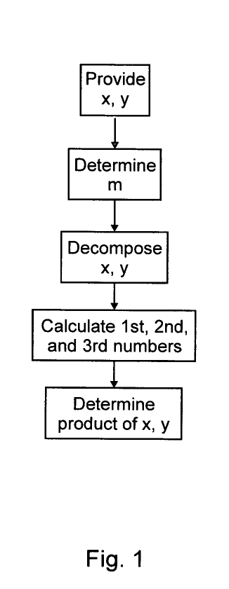

Referring to FIG. 1, a simplified flow diagram of a method according to an embodiment of the invention is shown. Two large numbers x and y are provided for multiplication. A value m is determined based on a logarithmic function and x and y. Both of x and y are decomposed into an exponent portion and another portion, a sum of the exponent portion multiplied by an exponent and the another portion equaling the associated one of x and y. In accordance with Karatsuba multiplication, a first value is computed from the decomposed x. In accordance with Karatsuba multiplication, a second value is computed from the decomposed y. A third value is then computed in a fashion that other than requires a multiplication of operands having a length longer than that of the exponent portion or the another portion of each of x and y. From the first value, the second value, and the third value a value for the product of x and y is determined in a fashion similar to that used for the Karatsuba method as follows: (first value)(10^{2m})+(third value)(10^{m})+(second value).

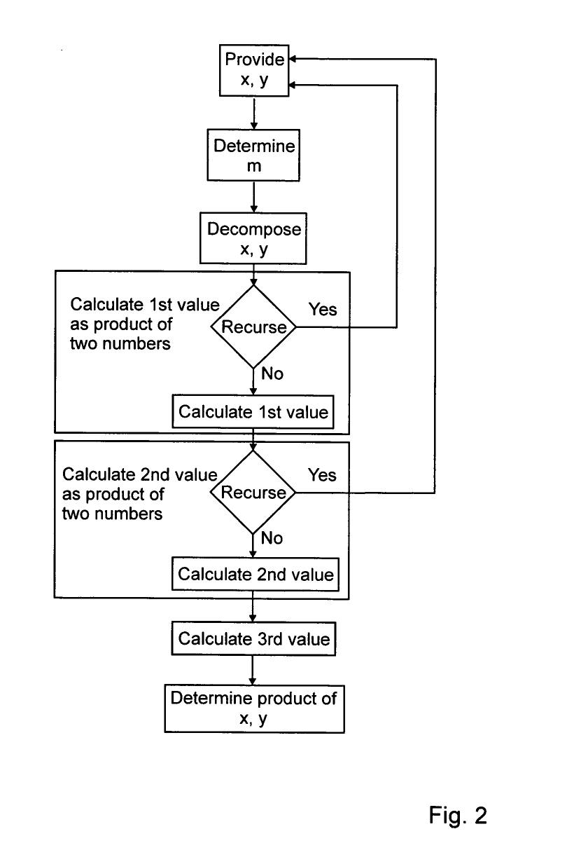

Referring to FIG. 2, a simplified flow diagram of a recursive embodiment of the invention is shown. Two large numbers x and y are provided for multiplication. A value m is determined based on a logarithmic function and x and y. Both of x and y are decomposed into an exponent portion and another portion, a sum of the exponent portion multiplied by an exponent and the another portion equaling the associated one of x and y. In accordance with Karatsuba multiplication, a first value is computed from the decomposed x. Here the first value is computed using a method according to an embodiment of the invention. The process recurses until the operands have a length below a predetermined length. In accordance with Karatsuba multiplication, a second value is computed from the decomposed y. Here the second value is computed using a method according to an embodiment of the invention. The process recurses until the operands have a length below a predetermined length. A third value is then computed in a fashion that other than requires a multiplication of operands having a length longer than that of the exponent portion or the another portion of each of x and y. Optionally, this multiplication is performed using the inventive method. From the first value, the second value, and the third value a value for the product of x and y is determined in a fashion similar to that used for the Karatsuba method as follows: (first value)(10^{2m})+(third value)(10^{m})+(second value).

Optionally, Karatsuba multiplication is used for each of the recursions absent modifications thereto described herein.

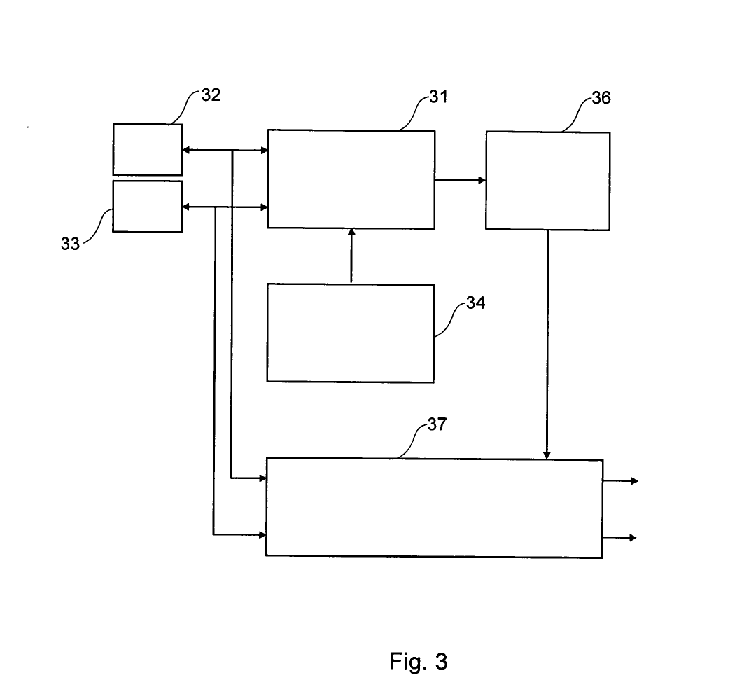

Referring to FIG. 3, a simplified block diagram of a circuit according to an embodiment of the invention is shown. An m bit multiplier block 31 is shown. A first memory store 32 and a second memory store 33 are shown for receiving values of x and y for multiplication. The values in memory stores 32 and 33 are deconstructed into two component values in block 34. Those values are then provided to m bit multiplier block 31 for multiplication thereof. The values are also provided to third value determination block 36 for determination of a third value therefrom. The products and the third value are then combined in a combining circuit 37 to result in the product in a fashion similar to that used for the Karatsuba method. Optionally, the circuit is implemented in a recursive fashion to perform multiplications of component values using a same or similar circuits.

Referring to Appendix A, source code is shown for an implementation of an embodiment in software. The implementation is shown for the programming language c. As is shown, the process is implemented for an 8×8 multiplication. Here, mid is the variable for storing of C, ab is the variable for storing of A and cd is the variable for storing of B. One of skill in the art is able to determine from the source code implementation details for implementing embodiments of the present invention.

Numerous other embodiments may be envisioned without departing from the spirit or scope of the invention.

What is claimed is:

1. A method comprising:
providing data for encryption;
encrypting the data comprising:
multiplying integers x and y comprising:
determining a value of x₁ and of x₂ such that x=x₁a^{m}+x₂, a is an integer,
determining a value of y₁ and of y₂ such that y=y₁a^{m}+y₂, a is an integer,
determining A=x₁y₁,
determining B=x₂y₂, and
determining C by performing an m bit multiplication operation and absent a
multiplication operation having operands having a length greater than m symbols; and,
providing the encrypted data.

2. A method according to claim 1 wherein determining C comprises:
determining C′=(x₁+x₂)[m−1:0]*(y₁+y₂)[m−1:0]; and,
determining C=C′+((y₁+y₂)[2m:0] AND (x₁+x₂)[m−1:0]+(x₁+x₂)[2m:0] AND (y₁+y₂)[m:0])<<m,
where << is a bitwise shift operation, wherein AND is performed by performing a Boolean AND of a single bit within a first operand with each bit within a second operand and wherein D[j:k] refers to the jth to kth bits of D.

3. A method according to claim 2 comprising:
determining xy=A10^{2m}+(C)10^{m}+B.

4. A method according to claim 1 comprising:
determining xy=A10^{2m}+(C)10^{m}+B.

5. A method according to claim 1 wherein determining C comprises a single m-bit multiply operation and a plurality of addition operations, shift operations and Boolean operations.

6. A method according to claim 5 wherein one or more of the addition operations involves at least an operator longer than m bits.

7. A method according to claim 5 wherein the single multiply operation is an m bit multiply operation and wherein the plurality of addition operations includes an m bit addition operation and an m+1 bit addition operation.

8. A method according to claim 7 wherein the single multiply operation, the m bit addition operation and the m+1 bit addition operation are within the critical path for determining a product of x and y.

9. A circuit comprising:
a decomposition circuit for determining a value of x₁ and of x₂ such that x=x₁a^{m}+x₂ and for determining a value of y₁ and y₂ such that y=y₁a^{m}+y₂, a is an integer;
a multiplier circuit for determining A=x₁y₁ and B=x₂y₂; and
a third circuit for determining C by performing an m bit multiplication operation and absent a multiplication operation having operands having a length greater than m symbols.

10. A circuit according to claim 9 wherein the third circuit includes Boolean circuitry for determining C′=(x₁+x₂)[m−1:0]*(y₁+y₂)[m−1:0] and for determining C=C′+((y₁+y₂)[2m:2m] AND (x₁+x₂)[m−1:0]+(x₁+x₂)[2m:2m] AND (y₁+y₂)[m:0])<<m, where << is a bitwise shift operation, wherein AND is performed by performing a Boolean AND of a single bit within a first operand with each bit within a second operand and wherein D[j:k] refers to the jth to kth bits of D.

11. A circuit according to claim 10 comprising:
a combiner circuit for determining a product of x and y by summing A10^{2m}+(C)10^{m}+B.

12. A method according to claim 9 comprising:
a combiner circuit for determining a product of x and y by summing A10^{2m}+(C)10^{m}+B.

13. A circuit according to claim 9 wherein the third circuit relies on a single m-bit multiplication operation and a plurality of addition operations, shift operations and Boolean operations.

14. A circuit according to claim 13 wherein the third circuit includes addition circuitry for supporting an addition operation with at least an operator longer than m bits.

15. A circuit according to claim 13 wherein the single multiply operation is an m bit multiply operation and wherein the plurality of addition operations includes an m bit addition operation and an m+1 bit addition operation.

16. A circuit according to claim 15 comprising a critical data flow path, wherein the single multiply operation, the m bit addition operation and the m+1 bit addition operation are within the critical data flow path for determining a product of x and y.

17. A storage medium having data stored therein, the data for when executed resulting in a circuit design comprising:
a decomposition circuit for determining a value of x₁ and of x₂ such that x=x₁a^{m}+x₂ and for determining a value of y₁ and y₂ such that y=y₁a^{m}+y₂, a is an integer;
a multiplier circuit for determining A=x₁y₁ and B=x₂y₂; and
a third circuit for determining C by performing an m bit multiplication operation and absent a multiplication operation having operands having a length greater than m.

18. A storage medium having data stored therein according to claim 17, the data for when executed resulting in a circuit design wherein the third circuit includes Boolean circuitry for determining C′=(x₁+x₂)[m−1:0]*(y₁+y₂)[m−1:0] and for determining C=C′+((y₁+y₂)[2m:2m] AND (x₁+x₂)[m−1:0]+(x₁+x₂)[2m:2m] AND (y₁+y₂)[m:0])<<m, where << is a bitwise shift operation, wherein AND is performed by performing a Boolean AND of a single bit within a first operand with each bit within a second operand and wherein D[j:k] refers to the jth to kth bits of D.

19. A storage medium having data stored therein according to claim 18 comprising a combiner circuit for determining a product of x and y by summing A 10^{2m}+(C)10^{m}+B.

20. A storage medium having data stored therein according to claim 17 wherein the third circuit relies on a single m-bit multiplication operation and a plurality of addition operations, shift operations and Boolean operations.
